(19) United States
(12) Patent Application Publication
(10) Pub. No.: US 2022/0353743 A1
(43) Pub. Date: Nov. 3, 2022

(54) COMMUNICATION DEVICE, COMMUNICATION METHOD, AND COMMUNICATION SYSTEM

(71) Applicant: Woven Planet Holdings, Inc., Tokyo (JP)

(72) Inventors: Takahiro ITO, Tokyo-to (JP); Naoya KANEKO, Tokyo-to (JP)

(73) Assignee: Woven Planet Holdings, Inc., Tokyo (JP)

(21) Appl. No.: 17/731,756

(22) Filed: Apr. 28, 2022

(30) Foreign Application Priority Data
Apr. 30, 2021 (JP) 2021-077168

(51) Int. Cl. H04W 28/08; H04W 76/15; H04W 4/40

(52) U.S. Cl. CPC H04W 28/0875; H04W 28/0967; H04W 76/15; H04W 4/40

(57) ABSTRACT

A communication device is installed on a moving body and capable of communicating with an external device via a plurality of communication lines. The communication device includes a controller configured to transmit streaming data to the external device via at least one of the plurality of communication lines. The controller determines whether or not prediction accuracy of a line quality of each of the plurality of communication lines at a moving body position being a position of the moving body satisfies an allowable condition. When the prediction accuracy of the line quality at the moving body position does not satisfy the allowable condition, the controller transmits, at the moving body position, same packets of the streaming data in parallel via the plurality of communication lines to the external device.

### CROSS-REFERENCE TO RELATED APPLICATION

This application claims priority to Japanese Patent Application No. 2021-077168 filed on Apr. 30, 2021, the entire contents of which are incorporated by reference herein.

### BACKGROUND

### Technical Field

The present disclosure relates to a communication technique applied to a moving body.

### Background Art

Patent Literature 1 discloses a communication device. The communication device includes a device management unit, a surrounding environment information collection unit, a communication unit, a communication prediction unit, and a communication control unit. The device management unit generates device information including position information of the communication device. The surrounding environment information collection unit collects surrounding environment information on an environment around the communication device. The communication unit performs a communication with an external communication device. The communication prediction unit predicts a communication quality of the communication unit by the use of the device information and the surrounding environment information. The communication control unit controls a communication setting of the communication unit based on the communication quality predicted by the communication prediction unit.

### List of Related Art

International Publication No. WO2020/217459

### SUMMARY

A situation where a moving body such as a vehicle and a robot externally transmits streaming data is considered. When a quality of a communication line used deteriorates, a quality of the streaming data on the receiving side deteriorates. Although it is conceivable to predict a line quality and to switch a communication line to be used in consideration of the line quality, it is not always easy to predict the line quality with high accuracy. Selecting the communication line based on an inaccurate line quality results in deterioration in quality of the streaming data on the receiving side after all. The case where prediction of a communication quality is difficult is not considered in the above-mentioned Patent Literature 1.

An object of the present disclosure is to provide a technique that can secure a data quality of streaming data transmitted from a moving body even in a situation where prediction of a line quality is difficult.

A first aspect is directed to a communication device that is installed on a moving body and capable of communicating with an external device via a plurality of communication lines.

The communication device includes a controller configured to transmit streaming data to the external device via at least one of the plurality of communication lines.

Moreover, the controller determines whether or not prediction accuracy of a line quality of each of the plurality of communication lines at a moving body position being a position of the moving body satisfies an allowable condition.

When the prediction accuracy of the line quality at the moving body position does not satisfy the allowable condition, the controller transmits, at the moving body position, same packets of the streaming data in parallel via the plurality of communication lines to the external device.

A second aspect is directed to a communication method that performs a communication between a moving body and an external device via a plurality of communication lines.

The communication method includes a streaming communication process that transmits streaming data from the moving body to the external device via at least one of the plurality of communication lines.

The streaming communication process includes:

determining whether or not prediction accuracy of a line quality of each of the plurality of communication lines at a moving body position being a position of the moving body satisfies an allowable condition; and

when the prediction accuracy of the line quality at the moving body position does not satisfy the allowable condition, transmitting, at the moving body position, same packets of the streaming data in parallel via the plurality of communication lines to the external device.

A third aspect is directed to a communication system.

The communication system includes:

a first communication device installed on a moving body; and

a second communication device connected to the first communication device via a communication network.

The first communication device is capable of communicating with the second communication device via a plurality of communication lines.

The first communication device transmits streaming data to the second communication device via at least one of the plurality of communication lines.

Moreover, the first communication device determines whether or not prediction accuracy of a line quality of each of the plurality of communication lines at a moving body position being a position of the moving body satisfies an allowable condition.

When the prediction accuracy of the line quality at the moving body position does not satisfy the allowable condition, the first communication device transmits, at the moving body position, same packets of the streaming data in parallel via the plurality of communication lines to the second communication device.

According to the present disclosure, it is determined whether or not the prediction accuracy of the line quality of each communication line at the moving body position satisfies the allowable condition. When the prediction accuracy of the line quality at the moving body position does not satisfy the allowable condition, a packet duplicate transmission process is performed at the moving body position. More specifically, same packets of the streaming data are transmitted in parallel via the plurality of communication lines. Thus, even when the line quality of each communication line is uncertain, at least a communication line with a high line quality at that timing is used. As a result, occurrence of packet loss is suppressed, and the deterioration in quality of the streaming data on the receiving side is suppressed. That is, it is possible to secure the data quality of the streaming data transmitted from the moving body even in a situation where the prediction of the line quality is difficult.

### BRIEF DESCRIPTION OF DRAWINGS

FIG. 1 is a conceptual diagram showing an outline of a communication system according to an embodiment of the present disclosure;

FIG. 2 is a conceptual diagram for explaining an application example of a communication system according to an embodiment of the present disclosure;

FIG. 3 is a block diagram showing a configuration example of a communication system according to an embodiment of the present disclosure;

FIG. 4 is a block diagram showing a concrete example of a communication system according to an embodiment of the present disclosure;

FIG. 5 is a conceptual diagram for explaining a packet duplicate transmission process according to an embodiment of the present disclosure;

FIG. 6 is a block diagram showing a configuration example related to a communication record according to an embodiment of the present disclosure;

FIG. 7 is a block diagram showing another configuration example related to a communication record according to an embodiment of the present disclosure;

FIG. 8 is a flow chart showing in a summarizing manner a streaming communication process according to an embodiment of the present disclosure; and

FIG. 9 is a timing chart showing an example of a streaming communication process according to an embodiment of the present disclosure.

### EMBODIMENTS

Embodiments of the present disclosure will be described with reference to the accompanying drawings.

### 1. Communication System

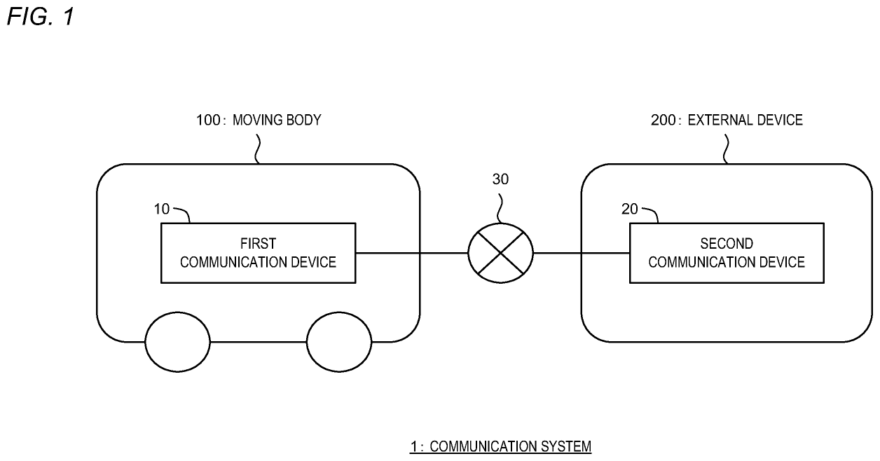

FIG. 1 is a conceptual diagram showing an outline of a communication system 1 according to the present embodiment. The communication system 1 includes a first communication device 10, a second communication device 20, and a communication network 30. The first communication device 10 and the second communication device 20 are connected to each other via the communication network 30. The first communication device 10 and the second communication device 20 is able to communicate with each other via the communication network 30.

In the present embodiment, at least one of the first communication device 10 and the second communication device 20 is installed on a moving body. Examples of the moving body include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

In the following description, the first communication device 10 is installed on a moving body 100. The second communication device 20 is installed on an external device 200 outside the moving body 100. A type of the external device 200 is not limited in particular. For example, the external device 200 is a management server for managing the moving body 100. As another example, the external device 200 may be a remote support device that remotely supports an operation of the moving body 100. As yet another example, the external device 200 may be a moving body different from the moving body 100. Typically, the first communication device 10 of the moving body 100 and the second communication device 20 of the external device 200 performs a wireless communication. However, the present embodiment is not limited to the wireless communication.

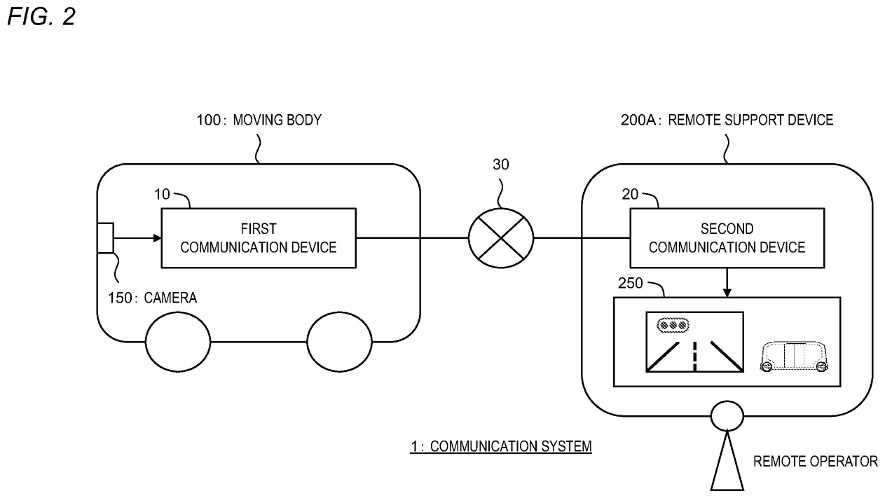

FIG. 2 is a conceptual diagram for explaining an application example of the communication system 1 according to the present embodiment. In the example shown in FIG. 2, the communication system 1 is utilized for “remote support” that remotely supports an operation of the moving body 100. More specifically, a camera 150 is installed on the moving body 100. The camera 150 images a situation around the moving body 100 to acquire image information. The first communication device 10 transmits the image information to a remote support device 200A being an example of the external device 200. The second communication device 20 of the remote support device 200A receives the image information from the moving body 100. The remote support device 200A displays the received image information on a display device 250. A remote operator looks at the image information displayed on the display device 250 to grasp the situation around the moving body 100 and remotely support the operation of the moving body 100. Examples of the remote support by the remote operator include recognition support, judgement support, remote driving, and the like. An instruction from the remote operator is transmitted from the second communication device 20 to the first communication device 10 of the moving body 100. The moving body 100 operates according to the instruction from the remote operator.

A variety of streaming data may be transmitted from the moving body 100 to the external device 200. For example, in the case of the remote support shown in FIG. 2, a video streaming data acquired by the camera 150 is transmitted. It is also conceivable that a plurality of video streaming data respectively acquired by a plurality of cameras 150 are transmitted simultaneously. In addition, an audio streaming data acquired by a microphone installed on the moving body 100 may be transmitted.

The first communication device 10 of the moving body 100 according to present embodiment is configured to be capable of communicating with the external device 200 via a plurality of communication lines. Since the number of communication lines that can be used simultaneously is increased, it becomes easy to ensure a communication rate as a whole, that is, data quality as a whole. The first communication device 10 transmits the plurality of streaming data to the external device 200 by using a necessary number of communication lines among the plurality of communication lines.

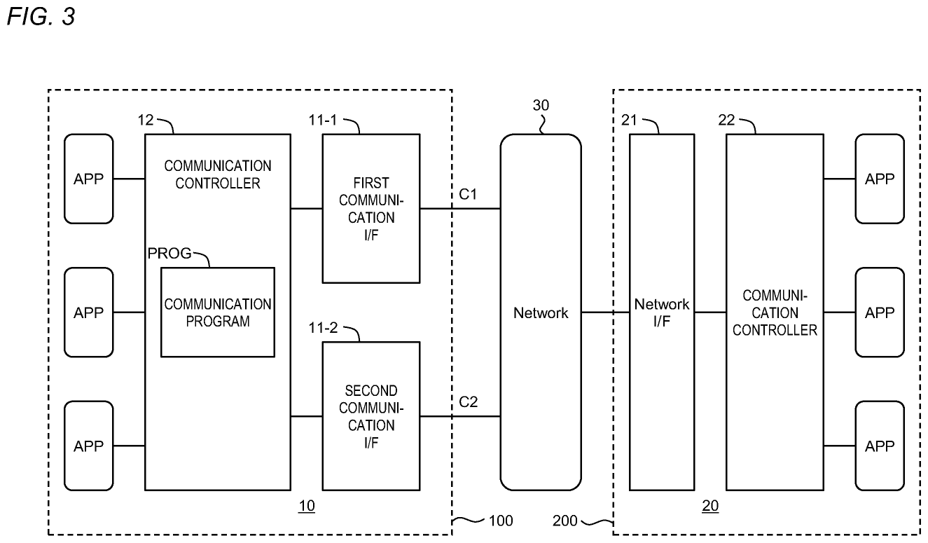

FIG. 3 is a block diagram showing a configuration example of the communication system 1 according to the present embodiment.

The first communication device 10 supports multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like. A communication cost differs among the multiple types of communication methods. In the example above, the wireless LAN method is the lowest and the common cellular method is the highest.

As shown in FIG. 3, the first communication device 10 includes a plurality of communication interfaces 11 and a communication controller 12.

The plurality of communication interfaces 11 are connected to the communication network 30 and perform communications with the second communication device 20 based on the multiple types of communication methods, respectively. For example, a first communication interface 11-1 performs a communication based on a first communication method. A second communication interface 11-2 performs a communication based on a second communication method different from the first communication method. It should be noted that the plurality of communication interfaces 11 may be realized by different physical interfaces, or may be realized by a combination of a common physical interface and different logical interfaces.

The plurality of communication lines are established based on the multiple types of communication methods, respectively. That is, the plurality of communication lines are associated with the multiple types of communication methods, respectively. It can also be said that the plurality of communication lines are associated with the plurality of communication interfaces 11, respectively. The plurality of communication interfaces 11 communicate with the second communication device 20 via the plurality of communication lines, respectively. For example, the first communication interface 11-1 performs the communication via a first communication line C1 based on the first communication method. The second communication interface 11-2 performs the communication via a second communication line C2 based on the second communication method.

The communication controller 12 is provided to control data transmitted and received by at least one application running on the moving body 100. For example, the communication controller 12 acquires the streaming data transmitted from at least one application to the external device 200 (i.e., the second communication device 20). The communication controller 12 allocates the streaming data to one or more of the plurality of communication interfaces 11 to be used. Then, the communication controller 12 transmits the streaming data to the external device 200 via the allocated communication interface 11 (i.e., the allocated communication line).

Moreover, the communication controller 12 performs “congestion control” that reduces a quality of the streaming data, as necessary. For example, in the case of the image (video) streaming data, the congestion control reduces its quality by lowering a resolution or a frame rate. As another example, the congestion control may reduce the quality of the streaming data by changing a compression rate.

The communication controller 12 is realized, for example, by a cooperation of a computer and a computer program. The moving body 100 is provided with a computer including a processor and a memory device. The computer program that provides the functions of the communication controller 12 is hereinafter referred to as a “communication program PROG.” The communication program PROG is stored in the memory device. The functions of the communication controller 12 are realized by the processor (the computer) executing the communication program PROG. It should be noted that the communication program PROG may be recorded on a non-transitory computer-readable recording medium. The communication program PROG may be provided via a network.

The second communication device 20 includes a network interface 21 and a communication controller 22. The network interface 21 is connected to the communication network 30 and communicates with the first communication device 10.

The communication controller 22 is provided to control data transmitted and received by at least one application running on the external device 200. For example, the communication controller 22 receives via the network interface 21 the streaming data transmitted from the first communication device 10. Then, the communication controller 22 outputs the streaming data to a destination application.

The communication controller 22 is realized, for example, by a cooperation of a computer and a computer program. The external device 200 is provided with a computer including a processor and a memory device. The computer program is stored in the memory device. The functions of the communication controller 22 are realized by the processor (the computer) executing the computer program.

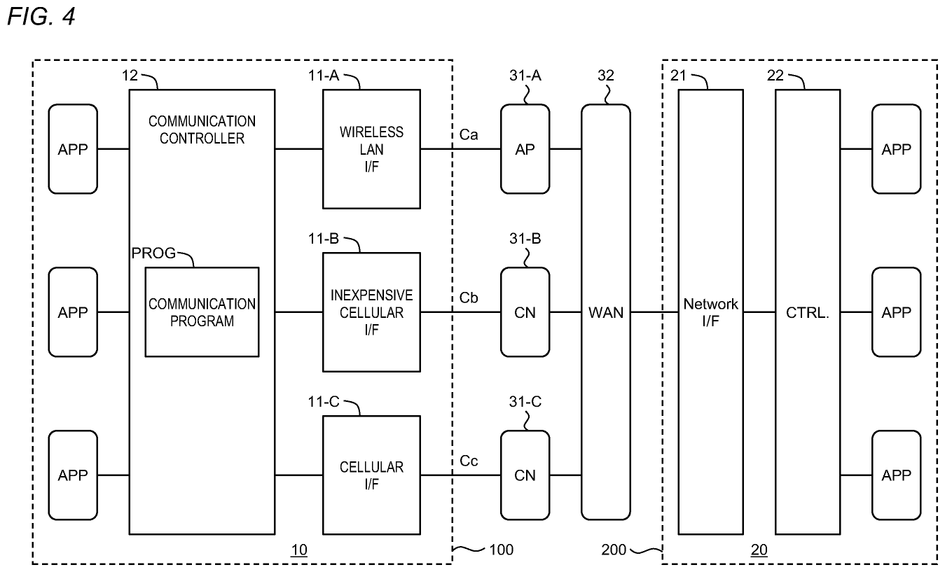

FIG. 4 is a block diagram showing a concrete example of the communication system 1 according to the present embodiment.

The plurality of communication interfaces 11 of the first communication device 10 include a wireless LAN interface 11-A, an inexpensive cellular interface 11-B, and a cellular interface 11-C. The wireless LAN interface 11-A performs a communication via a communication line Ca based on a wireless LAN method (system). The wireless LAN interface 11-A is connected to a communication network 32 (e.g., a WAN) via an access point 31-A. The inexpensive cellular interface 11-B performs a communication via a communication line Cb based on an inexpensive cellular method (system). The inexpensive cellular interface 11-B is connected to the communication network 32 via a cellular network 31-B. The cellular interface 11-C performs a communication via a communication line Cc based on a common cellular method (system). The cellular interface 11-C is connected to the communication network 32 via a cellular network 31-C.

In the case of the example shown in FIG. 4, the communication cost is lower in an order of the communication line Ca based on the wireless LAN method, the communication line Cb based on the inexpensive cellular method, and the communication line Cc based on the common cellular method.

### 2. Streaming Communication Process Considering Line Quality

### 2-1. Normal Streaming Communication Process

First, a normal streaming communication process by the communication controller 12 of the first communication device 10 will be described. The communication controller 12 measures or predicts a line quality of each of the plurality of communication lines. Examples of the line quality include a communication rate (throughput), a communication delay, and the like. The communication controller 12 selects one or more communication lines from the plurality of communication lines in consideration of the line quality. Then, the communication controller 12 transmits the streaming data to the external device 200 via the selected communication line (i.e., the selected communication interface 11).

Typically, the communication controller 12 selects one with the highest line quality from the plurality of communication lines. For example, the communication controller 12 selects one with the highest throughput from the plurality of communication lines. That is, the communication controller 12 switches a communication line to be used in consideration of the line quality. It is thus possible to secure a data quality of the streaming data.

As another example, the communication controller 12 may select two or more communication lines and concurrently use the two or more communication lines. For example, the communication controller 12 acquires (measures or estimates) a throughput of each of the first communication line C1 and the second communication line C2. The communication controller 12 divides the streaming data with a distribution ratio (weight) according to the throughput. Then, the communication controller 12 transmits the two divided streaming data via the first communication line C1 and the second communication line C2, respectively. It is thus possible to increase the throughput as a whole and to secure the data quality of the streaming data as much as possible.

As yet another example, the communication controller 12 may select one or more communication lines from the plurality of communication lines in consideration of the communication cost in addition to the line quality.

### 2-2. Packet Duplicate Transmission Process

When the quality of the communication line used deteriorates when the streaming data is transmitted from the moving body 100, a quality of the streaming data on the receiving side deteriorates. Although it is conceivable to predict the line quality and to switch the communication line to be used in consideration of the line quality, it is not always easy to predict the line quality with high accuracy. Selecting the communication line based on an inaccurate line quality results in deterioration in quality of the streaming data on the receiving side after all.

According to the present embodiment, the communication controller 12 performs the streaming communication process in further consideration of whether or not it is possible to predict the line quality with high accuracy. More specifically, the communication controller 12 determines whether or not prediction accuracy of the line quality of each communication line at a moving body position satisfies an allowable condition. Here, the “moving body position” is a current position or a future position of the moving body 100. Various examples are conceivable as a method for determining whether or not the prediction accuracy of the line quality at the moving body position satisfies the allowable condition. Various examples of the method will be described later. When the prediction accuracy of the line quality at the moving body position does not satisfy the allowable condition, the communication controller 12 performs a “packet duplicate transmission process” at the moving body position.

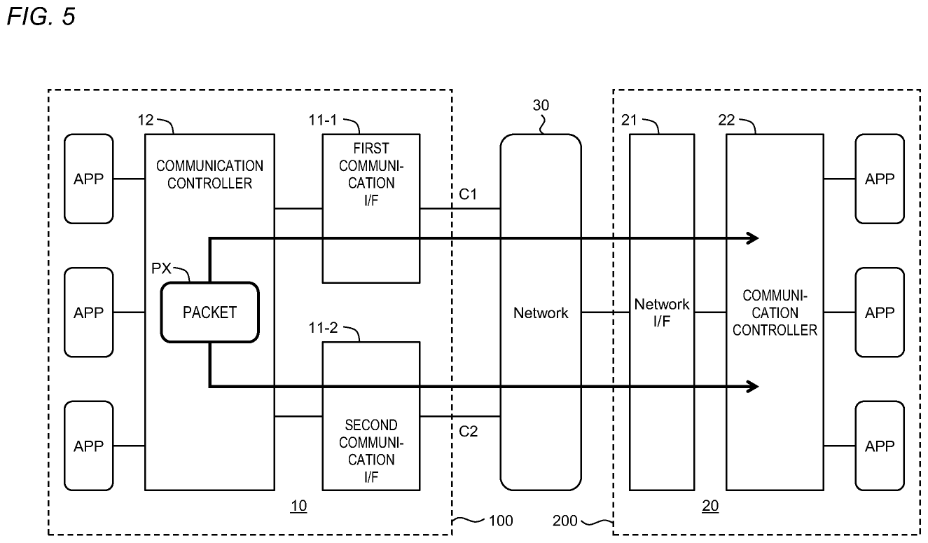

FIG. 5 is a conceptual diagram for explaining the packet duplicate transmission process. A packet PX constituting the streaming data is considered. In the packet duplicate transmission process, the communication controller 12 concurrently uses the plurality of communication lines and transmits the same (identical) packets PX in parallel via the plurality of communication lines to the external device 200. In an example shown in FIG. 5, the communication controller 12 concurrently transmits the same packets PX in parallel via the first communication line C1 and the second communication line C2 to the external device 200.

The communication controller 22 of the second communication device 20 on the receiving side may receive the same packets PX via the plurality of communication lines. In that case, the communication controller 22 may select a packet PX received earliest and discard another packet PX received later. For example, the communication controller 12 on the transmitting side gives identification information (e.g. an identification number) in a header of each transmission packet. The communication controller 22 on the receiving side grasps a reception history of each packet based on the identification information in the header of each received packet. Then, the communication controller 22 selects one received earliest and discards another received later among the same packets PX received via the plurality of communication lines.

As described above, according to the present embodiment, it is determined whether or not the prediction accuracy of the line quality of each communication line at the moving body position satisfies the allowable condition. When the prediction accuracy of the line quality at the moving body position does not satisfy the allowable condition, the packet duplicate transmission process is performed at the moving body position. More specifically, the same packets PX of the streaming data are transmitted in parallel via the plurality of communication lines. Thus, even when the line quality of each communication line is uncertain, at least a communication line with a high line quality at that timing is used. As a result, occurrence of packet loss is suppressed, and the deterioration in quality of the streaming data on the receiving side is suppressed. That is, it is possible to secure the data quality of the streaming data transmitted from the moving body 100 even in a situation where the prediction of the line quality is difficult.

For example, the streaming data are transmitted to the remote support device 200A and used for the remote support by the remote operator (see FIG. 2). Since the data quality of the streaming data is secured, accuracy of the remote support is improved.

It should be noted that as the number of communication lines used at the same time increases, the communication cost also increases. Therefore, there is no need to always perform the packet duplicate transmission process. Performing the packet duplicate transmission process only in the situation where the line quality cannot be predicted with high accuracy makes it possible to suppress unnecessary increase in the communication cost.

### 2-3. Examples of Allowable Condition for Line Quality Prediction Accuracy

Hereinafter, examples of the method for determining whether or not the prediction accuracy of the line quality at the moving body position satisfies the allowable condition will be described. The communication controller 12 determines, based on past communication records, whether or not the prediction accuracy of the line quality at the moving body position satisfies the allowable condition.

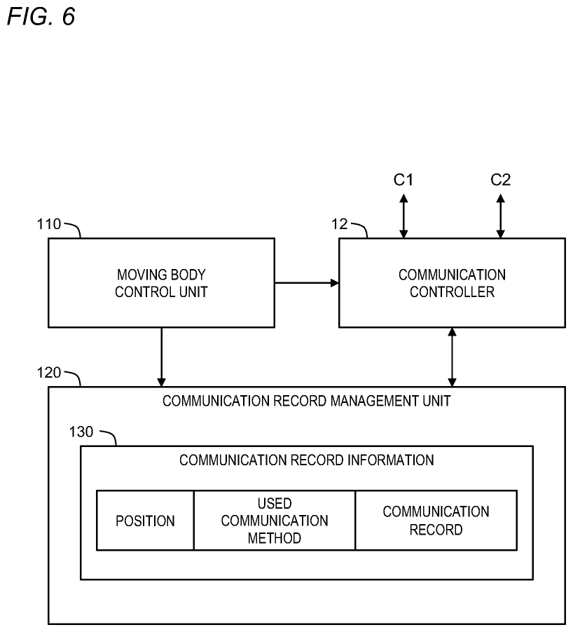

FIG. 6 is a block diagram showing a configuration example related to the communication record. The moving body 100 includes a moving body control unit 110 and a communication record management unit 120.

The moving body control unit 110 controls the moving body 100. For example, the moving body control unit 110 acquires the current position of the moving body 100. In addition, the moving body control unit 110 determines a target movement route to a destination. Then, the moving body control unit 110 controls the moving body 100 to move in accordance with the target movement route.

The communication record management unit 120 manages communication record information 130 that indicates the past communication records of the communication with the external device 200. The communication record information 130 indicates a correspondence relation between a “position”, a “used communication method”, and a “communication record.” The “position” here is defined, for example, by a latitude and a longitude. The “position” may be defined by a certain area. The “used communication method” is a communication method used in the past at the “position.” The communication method and the communication line are associated with each other. The “communication record” indicates a communication record by the “used communication method” at the “position.” For example, the “communication record” indicates a communication parameter at the time of the communication with the external device 200 in the past by the use of the “communication method” at the “position.” Examples of the communication parameter include a throughput, a round trip time, a radio field strength, a jitter, and the like. The “communication record” may indicate statistical information such as a variance of the past communication parameter.

The communication record management unit 120 receives information of the current position of the moving body 100 from the moving body control unit 110. Moreover, the communication record management unit 120 receives information of the used communication method and the communication record (e.g., the communication parameter) from the communication controller 12. Then, the communication record management unit 120 registers the correspondence relation between the current position of the moving body 100, the used communication method, and the communication record (e.g., the communication parameter) in the communication record information 130.

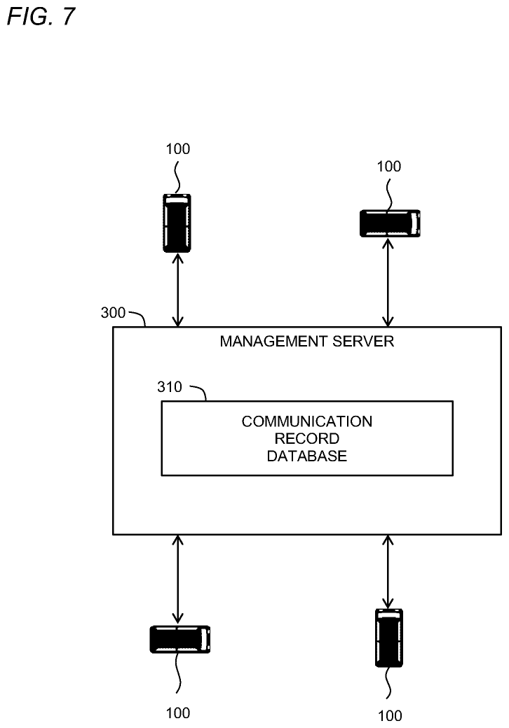

FIG. 7 shows a modification example. The communication record information 130 may be shared by a plurality of moving bodies 100. More specifically, a management server 300 communicating with the plurality of moving bodies 100 is provided. Each moving body 100 generates the communication record information 130 regarding its own communication record and transmits the communication record information 130 to the management server 300. The management server 300 collects the communication record information 130 from the plurality of moving bodies 100 and registers it in a communication record database 310. That is, the management server 300 aggregates and manages the communication record information 130 generated by each of the plurality of moving bodies 100. Each moving body 100 can request the management server 300 to provide the communication record information 130 of a necessary position. The management server 300 provides the communication record information 130 of the requested position to the moving body 100 being a request source. By sharing the communication record information 130 in this manner, each moving body 100 is able to acquire plenty and precise communication record information 130.

The communication controller 12 is able to access the communication record management unit 120 (i.e., the communication record information 130). The communication record management unit 120 may be included in the communication controller 12. The communication controller 12 receives information on the moving body position from the moving body control unit 110. The moving body position is the current position or a future position of the moving body 100. The future position of the moving body 100 can be calculated from the current position and the target movement route. Based on the communication record information 130, the communication controller 12 acquires the communication record of each communication method (i.e., the communication line) related to the moving body position. Then, the communication controller 12 determines, based on the communication record related to the moving body position, whether or not the prediction accuracy of the line quality at the moving body position satisfies the allowable condition.

For example, the communication controller 12 acquires a variance of the past communication parameter indicated by the communication record related to the moving body position. Then, the communication controller 12 compares the variance of the past communication parameter with a predetermined threshold. When the variance of the past communication parameter is equal to or less than the predetermined threshold, the communication controller 12 determines that the prediction accuracy of the line quality at the moving body position is high, that is, satisfies the allowable condition. On the other hand, when the variance of the past communication parameter is greater than the predetermined threshold, the communication controller 12 determines that the prediction accuracy of the line quality at the moving body position is low, that is, does not satisfy the allowable condition.

As another example, the communication controller 12 acquires an accumulated amount of the communication record related to the moving body position. Then, the communication controller 12 compares the accumulated amount of the communication record with a predetermined threshold. When the accumulated amount of the communication record is equal to or greater than the predetermined threshold, the communication controller 12 determines that the prediction accuracy of the line quality at the moving body position is high, that is, satisfies the allowable condition. On the other hand, when the accumulated amount of the communication record is less than the predetermined threshold, the communication controller 12 determines that the prediction accuracy of the line quality at the moving body position is low, that is, does not satisfy the allowable condition.

As yet another example, the communication controller 12 acquires the past communication parameter indicated by the communication record related to the moving body position. Moreover, the communication controller 12 acquires a current communication parameter at the moving body position. Then, the communication controller 12 compares a difference between the past communication parameter and the current communication parameter with a predetermined threshold. When the difference between the past communication parameter and the current communication parameter is equal to or less than the predetermined threshold, the communication controller 12 determines that the prediction accuracy of the line quality at the moving body position is high, that is, satisfies the allowable condition. On the other hand, when the difference between the past communication parameter and the current communication parameter is greater than the predetermined threshold, the communication controller 12 determines that the prediction accuracy of the line quality at the moving body position is low, that is, does not satisfy the allowable condition.

### 2-4. Processing Flow

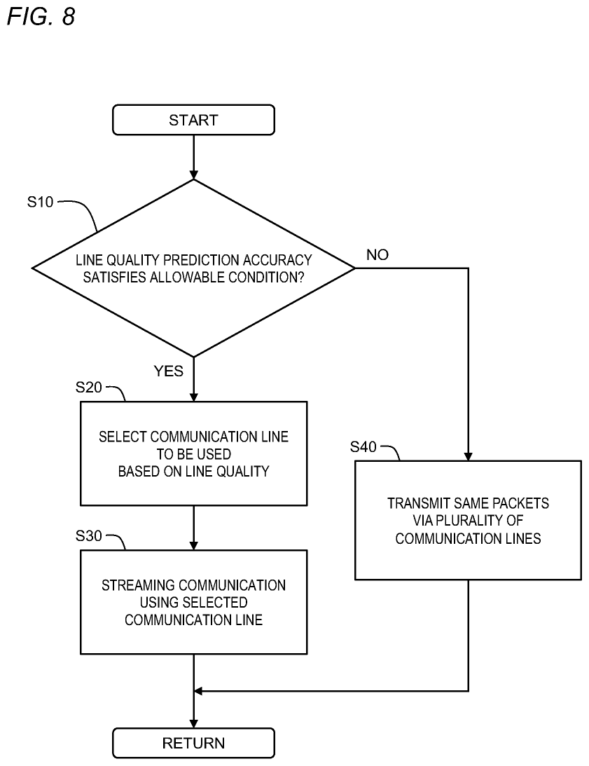

FIG. 8 is a flow chart showing in a summarizing manner the streaming communication process according to the present embodiment.

In Step S10, the communication controller 12 determines whether or not the prediction accuracy of the line quality at the moving body position satisfies the allowable condition. The determination method is as described in the above Section 2-3. When the prediction accuracy of the line quality at the moving body position satisfies the allowable condition (Step S10; Yes), the processing proceeds to Step S20. On the other hand, when the prediction accuracy of the line quality at the moving body position does not satisfy the allowable condition (Step S10; No), the processing proceeds to Step S40.

In Step S20, the communication controller 12 selects one or more communication lines from the plurality of communication lines in consideration of the line quality. The method for selecting the communication line is as described in the above Section 2-1.

In Step S30, the communication controller 12 transmits the streaming data to the external device 200 via the selected communication line (i.e., the selected communication interface 11).

In Step S40, the communication controller 12 performs the packet duplicate transmission process (see Section 2-2). More specifically, the communication controller 12 transmits the same packets of the streaming data in parallel via the plurality of communication lines to the external device 200. The communication controller 22 on the receiving side selects one received earliest and discards another received later among the same packets received via the plurality of communication lines.

### 2-5. Example of Streaming Communication Process

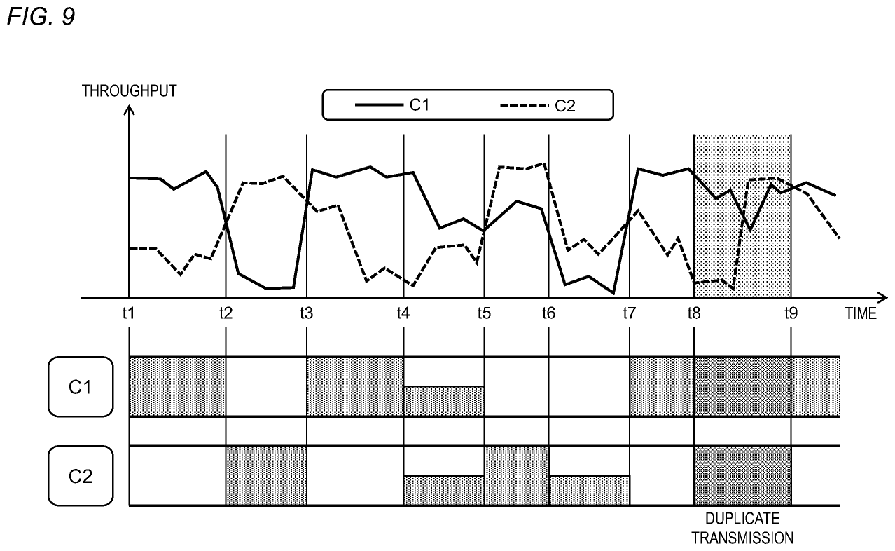

FIG. 9 is a timing chart showing an example of the streaming communication process according to the present embodiment. A horizontal axis represents time, and a vertical axis represents a throughput (estimate value) of the communication line. Here, two types, the first communication line C1 and the second communication line C2 are considered. A solid line represents a throughput X1 [bps] of the first communication line C1, and a dashed line represents a throughput X2 [bps] of the second communication line C2. It is assumed that a required communication rate that is required for transmitting the streaming data is N [bps].

In a period from a time t1 to a time t2, the throughput X1 of the first communication line C1 is higher than the throughput X2 of the second communication line C2 and is equal to or higher than the required communication rate N. In this period, the first communication line C1 is selected.

In a period from the time t2 to a time t3, the throughput X2 of the second communication line C2 is higher than the throughput X1 of the first communication line C1 and is equal to or higher than the required communication rate N. In this period, the second communication line C2 is selected.

In a period from the time t3 to a time t4, the throughput X1 of the first communication line C1 is higher than the throughput X2 of the second communication line C2 and is equal to or higher than the required communication rate N. In this period, the first communication line C1 is selected.

In a period from the time t4 to a time t5, each of the throughputs X1 and X2 is lower than the required communication rate N, but a sum of the throughputs X1 and X2 is equal to or higher than the required communication rate N (i.e., X1<N, X2<N, X1+X2>N). In this period, both the first communication line C1 and the second communication line C2 are selected. The streaming data is divided with a distribution ratio (weight) according to the throughput X1 and the throughput X2. Then, the two divided streaming data are transmitted via the first communication line C1 and the second communication line C2, respectively.

In a period from the time t5 to a time t6, the throughput X2 of the second communication line C2 is higher than the throughput X1 of the first communication line C1 and is equal to or higher than the required communication rate N. In this period, the second communication line C2 is selected.

In a period from the time t6 to a time t7, a sum of the throughputs X1 and X2 is lower than the required communication rate N (i.e., X1+X2<N). In this case, the congestion control is performed to reduce the amount of data to be transmitted.

In a period from the time t7 to a time t8, the throughput X1 of the first communication line C1 is higher than the throughput X2 of the second communication line C2 and is equal to or higher than the required communication rate N. In this period, the first communication line C1 is selected.

In a period from the time t8 to a time t9, the prediction accuracy of the line quality of each communication line at the moving body position does not satisfy the allowable condition. In this case, the packet duplicate transmission process is performed. Both the first communication line C1 and the second communication line C2 are selected, and the same packets of the streaming data are transmitted in parallel via the first communication line C1 and the second communication line C2.

### 3. Effects

As described above, according to the present embodiment, it is determined whether or not the prediction accuracy of the line quality of each communication line at the moving body position satisfies the allowable condition. When the prediction accuracy of the line quality at the moving body position does not satisfy the allowable condition, the packet duplicate transmission process is performed at the moving body position. More specifically, the same packets PX of the streaming data are transmitted in parallel via the plurality of communication lines. Thus, even when the line quality of each communication line is uncertain, at least a communication line with a high line quality at that timing is used. As a result, occurrence of packet loss is suppressed, and the deterioration in quality of the streaming data on the receiving side is suppressed. That is, it is possible to secure the data quality of the streaming data transmitted from the moving body 100 even in a situation where the prediction of the line quality is difficult.

For example, the streaming data are transmitted to the remote support device 200A and used for the remote support by the remote operator (see FIG. 2). Since the data quality of the streaming data is secured, accuracy of the remote support is improved.

It should be noted that as the number of communication lines used at the same time increases, the communication cost also increases. Therefore, there is no need to always perform the packet duplicate transmission process. Performing the packet duplicate transmission process only in the situation where the line quality cannot be predicted with high accuracy makes it possible to suppress unnecessary increase in the communication cost.

What is claimed is:

1. A communication device that is installed on a moving body and capable of communicating with an external device via a plurality of communication lines,
the communication device comprising a controller configured to transmit streaming data to the external device via at least one of the plurality of communication lines, wherein
the controller is further configured to:
determine whether or not prediction accuracy of a line quality of each of the plurality of communication lines at a moving body position being a position of the moving body satisfies an allowable condition; and
when the prediction accuracy of the line quality at the moving body position does not satisfy the allowable condition, transmit, at the moving body position, same packets of the streaming data in parallel via the plurality of communication lines to the external device.

2. The communication device according to claim 1, wherein
the plurality of communication lines are associated with a plurality of communication methods, respectively,
communication record information indicates a correspondence relation between a position, a used communication method used at the position among the plurality of communication methods, and a communication record by the used communication method, and
the controller is further configured to:
acquire the communication record related to the moving body position, based on the communication record information; and
determine, based on the communication record related to the moving body position, whether or not the prediction accuracy of the line quality at the moving body position satisfies the allowable condition.

3. The communication device according to claim 2, wherein
the controller is further configured to:
acquire a variance of a past communication parameter indicated by the communication record related to the moving body position; and
when the variance of the past communication parameter is greater than a threshold, determine that the prediction accuracy of the line quality at the moving body position does not satisfy the allowable condition.

4. The communication device according to claim 2, wherein
the controller is further configured to:
when an accumulated amount of the communication record related to the moving body position is less than a threshold, determine that the prediction accuracy of the line quality at the moving body position does not satisfy the allowable condition.

5. The communication device according to claim 2, wherein
the controller is further configured to:
acquire a past communication parameter indicated by the communication record related to the moving body position; and
when a difference between the past communication parameter and a current communication parameter at the moving body position is greater than a threshold, determine that the prediction accuracy of the line quality at the moving body position does not satisfy the allowable condition.

6. The communication device according to claim 1, wherein
an operation of the moving body is remotely supported by a remote operator based on the streaming data transmitted to the external device.

7. A communication method performing a communication between a moving body and an external device via a plurality of communication lines,
the communication method comprising a streaming communication process that transmits streaming data from the moving body to the external device via at least one of the plurality of communication lines, wherein
the streaming communication process comprises:
determining whether or not prediction accuracy of a line quality of each of the plurality of communication lines at a moving body position being a position of the moving body satisfies an allowable condition; and
when the prediction accuracy of the line quality at the moving body position does not satisfy the allowable condition, transmitting, at the moving body position, same packets of the streaming data in parallel via the plurality of communication lines to the external device.

8. A communication system comprising:
a first communication device installed on a moving body; and
a second communication device connected to the first communication device via a communication network, wherein
the first communication device is capable of communicating with the second communication device via a plurality of communication lines,
the first communication device is configured to:
transmit streaming data to the second communication device via at least one of the plurality of communication lines;
determine whether or not prediction accuracy of a line quality of each of the plurality of communication lines at a moving body position being a position of the moving body satisfies an allowable condition; and
when the prediction accuracy of the line quality at the moving body position does not satisfy the allowable condition, transmit, at the moving body position, same packets of the streaming data in parallel via the plurality of communication lines to the second communication device.

9. The communication system according to claim 8, wherein
the second communication device selects one received earliest and discards another received later among the same packets received via the plurality of communication lines.
